(19) United States
(12) Patent Application Publication
(10) Pub. No.: US 2020/0082105 A1
(43) Pub. Date: Mar. 12, 2020

(54) SYSTEM AND METHODOLOGY FOR SELECTIVE APPLICATION PERMISSIONING

(71) Applicant: Matrix Financial Technologies, Inc., Irivine, CA (US)

(72) Inventors: Eyal Shachar, Santa Ana, CA (US); Mark Peter Grieco, Orange, CA (US); Steven Dwight Albin, Irvine, CA (US); Eyal Marmareli, Irvine, CA (US)

(73) Assignee: Matrix Financial Technologies, Inc., Irivine, CA (US)

(21) Appl. No.: 16/129,409

(22) Filed: Sep. 12, 2018

(51) Int. Cl. G06F 21/62; G06F 21/60; H04L 29/06

(52) U.S. Cl. CPC G06F 21/629; G06F 21/604; G06F 2221/2141; H04L 63/20; H04L 63/102

(57) ABSTRACT

A system and methodology which enables applications to provide selective permissioning to view, access and/or use features and functionality based on one or more criteria. These criteria may be selected from one or more characteristics associated with the specific user or user group accessing the application. Alternatively or in addition, the permissioning criteria may be based on the amount of payment or fees that the specific user or user group has paid in order to access the application. The usage of other criteria is also possible. For example, permissioning criteria may also include the specific time/day/period that user is accessing the application, the then-current overall usage of the application and/or related resources at the time the application is accessed by the user as well as other criteria.

### FIELD OF THE INVENTION

The present invention is directed generally to systems and methodologies associated with selective permissioning, and, more particularly to systems and methodologies which operate to selectively permit or restrict access to various features, functionality and resources within an application platform.

### BACKGROUND OF THE INVENTION

Computer driven applications are prevalent in today's world. These applications touch on a great many aspects of our lives including, how we create documents, how we schedule our appointments, how we bank and conduct other financial transactions and how we get our news. These are just a few examples and there are perhaps hundreds or thousands of other areas where these applications improve life experiences as well as business operations.

Many of these applications are cloud based such that the primary functionality and processing associated with these applications is located on a server which is located remotely from the users of the application. One particular advantage of this arrangement is that updates and changes can be made to the application features and functionality at the server level without having to distribute and manage these changes across a broad user base.

While the applications are expansive in their capabilities and functionality, many such applications do suffer from the drawback of having a steep learning curve in order to be an effective and efficient user of the application. In fact, many users of these relatively complex applications may never get to the point where they can leverage the true power of the application due to the inherent complexity and difficulty in learning how to use and access various features. In particular, brand new users with little to no experience with these application typically use the application in the exact same form as a very experienced user does. This causes the unfortunate consequence that new users may not be able to readily identify the basic features of the application in the context of the extensive and rich set of features, many of which are only required by advanced users. More specifically, novice users may be unable to determine where to access and how to use even the most basic features of an application due to complex action/feature menus and/or the presence of aspects of only needed by advanced users in the standard user interface.

Another drawback with the way existing applications are created and deployed for use is that these applications (whether cloud based or client based) are more easily managed and supported if there are a limited number of versions of each application in use. Thus, some application providers may offer only one version of an application which includes access to all features but comes at a cost which is not a true representation of the value of that application to an individual novice user (i.e. she will not use all of the available features which she is nonetheless paying for).

Alternatively, other application providers may offer a small number of applications which are available simultaneously. For example. some providers may offer a basic, a standard and a deluxe version of the same application in which feature/functionality varies along with price. While this provides some flexibility, it still does not permit developers and providers to customize and price application configurations on a more specific level.

There also exist other drawbacks with these applications. In some cases, it may be desirable to control access to application features/functionality based on what a user is willing to pay. In other cases, it may be desirable to control access to application features/functionality based on a user's specific role, position, level of attainment, knowledge level or other characteristics associated with the user. In still other cases, it may be desirable to control access to application features/functionality based on the user's experience and/or demonstrated proficiency with the relevant application. As a general matter, this selective control and permissioning with respect to applications is not available and the deployment of applications is often a “one-size-fits-all” or “a few-sizes-fits-all” approach which can result in several undesirable consequences such as users not deriving full value for what they pay and/or new users becoming frustrated with application complexities and/or completely giving up on the use of the application at the outset.

One particular area in which these drawbacks are particularly evident is in the design and deployment of web-based applications through which individuals can analyze and implement trades of various instruments such as stocks, bonds, options, commodities, currencies and other tradable assets. These applications may exist in the form of brokerage trading platforms, trading analysis systems, portfolio management tools, trading simulators, trading educational applications and/or some combination of the foregoing. Because the experience levels and interests of traders varies by such a large degree, it becomes difficult for the developers of these applications to provide a solution which on the one hand is robust enough for more experienced traders but on the other hand, easy enough for less experienced users to use.

### SUMMARY OF THE INVENTION

It is thus a primary object of the invention to provide a system and methodology that addresses the shortcomings of the prior art as discussed above.

It is another object of the present invention to provide a system and methodology which provides a computer implemented application which offers selective permissioning with respect to features and functionality.

It is a further object of the present invention to provide a system and methodology which provides a computer implemented application which offers selective permissioning and wherein such selective permissioning is implemented via a customizable user interface.

It is a still further object of the present invention to provide the foregoing selectively permissioned computer-implemented application in the form of a cloud based solution.

It is a yet further object of the present invention to provide a selectively permissioned computer-implemented application which permits for user interface customization based on the level of consideration or payment which is made by the user accessing the application.

It is another object of the present invention to provide a selectively permissioned computer-implemented application which permits for user interface customization based on the experience level of the user accessing the application with respect to use of such application.

It is a yet further object of the present invention to provide a selectively permissioned computer-implemented application which permits for user interface customization based on the level of education attained by the user accessing the application.

It is a still further object of the present invention to provide a selectively permissioned computer-implemented application which permits for user interface customization based on the level of consideration or payment which is made by the user accessing the application.

It is another object of the present invention to provide a selectively permissioned computer-implemented application which permits for user interface customization based on the trading characteristics associated with the user accessing the application, such characteristics including amount of trading capital available, specific instruments traded, risk tolerance, trading strategies traded, current portfolio composition and other trading related characteristics as desired.

It is a still further object of the present invention to provide a computer based trading system with novel reporting and display functionality such that possible trading actions are displayed in an easily readable and organized fashion through various differing display formats.

A primary objective the invention disclosed herein is a system and methodology which enables applications to provide selective permissioning to view, access and/or use features and functionality based on one or more criteria. These criteria may be selected from one or more characteristics associated with the specific user or user group accessing the application. Alternatively or in addition, the permissioning criteria may be based on the amount of payment or fees that the specific user or user group has paid in order to access the application. The usage of other criteria is also possible. For example, permissioning criteria may also include the specific time/day/period that user is accessing the application, the then-current overall usage of the application and/or related resources at the time the application is accessed by the user as well as other criteria.

The system and methodology of the present invention operate, in one embodiment, to provide a cloud based application platform in which external data is used to assess one or more permissioning criteria. As a result of this assessment, the user interface of the application and/or the availability of various features and functionality of the application may be selectively enabled or disabled.

The system and methodology of the present invention, in one embodiment, provides a cloud based and computer implemented trading system though which various users may access the application. Depending on various characteristics of these users, permissioning with respect to application functionality as well as what appears on the user interface and how it is arranged may be provided. By way of example, depending on trading preferences and experience, users may be selectively enabled, disabled, and/or limited in terms of instrument types available for trading, risk level of trades permitted, amount of capital available for trading, scope of features of analysis tools available as well as other features and functionality.

### BRIEF DESCRIPTION OF THE DRAWINGS

FIG. 1 is a diagram depicting the major components of the system of the present invention including the Application Permissioning Engine (APE) of the present invention in a preferred embodiment thereof; and

FIGS. 2-5 are an exemplary user interfaces demonstrating the permissioning functionality of the present invention.

### DETAILED DESCRIPTION OF THE INVENTION

The present disclosure will now be described in terms of various exemplary embodiments. This specification discloses one or more embodiments that incorporate features of the present embodiments. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. The skilled artisan will appreciate that a particular feature, structure, or characteristic described in connection with one embodiment is not necessarily limited to that embodiment but typically has relevance and applicability to one or more other embodiments.

In the several figures, like reference numerals may be used for like elements having like functions even in different drawings. The embodiments described, and their detailed construction and elements, are merely provided to assist in a comprehensive understanding of the present embodiments. Thus, it is apparent that the present embodiments can be carried out in a variety of ways, and does not require any of the specific features described herein. Also, well-known functions or constructions are not described in detail since they would obscure the present embodiments with unnecessary detail.

The description is not to be taken in a limiting sense, but is made merely for the purpose of illustrating the general principles of the present embodiments, since the scope of the present embodiments are best defined by the appended claims.

It should also be noted that in some alternative implementations, the blocks in a flowchart, the communications in a sequence-diagram, the states in a state-diagram, etc., may occur out of the orders illustrated in the figures. That is, the illustrated orders of the blocks/communications/states are not intended to be limiting. Rather, the illustrated blocks/communications/states may be reordered into any suitable order, and some of the blocks/communications/states could occur simultaneously.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an” and “the” are intended to include the plural forms as well, unless the context clearly indicates otherwise.

The word “exemplary” is used herein to mean “serving as an example, instance, or illustration.” Any embodiment described herein as “exemplary” is not necessarily to be construed as preferred or advantageous over other embodiments. Additionally, all embodiments described herein should be considered exemplary unless otherwise stated.

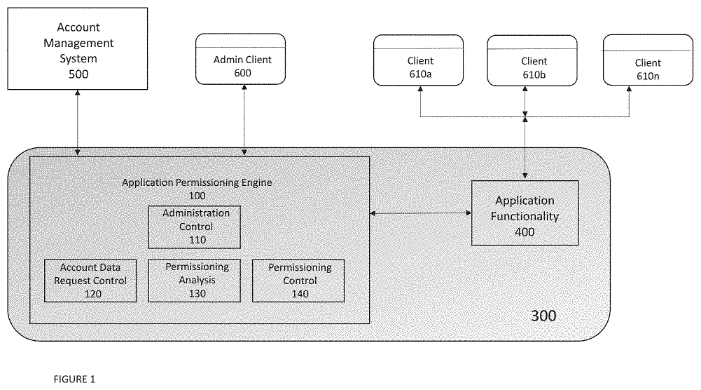

With reference now to FIG. 1, the system of the present invention, in a preferred embodiment thereof, is now described. According to a preferred embodiment, Application Permissioning Engine (APE) 100 and application functionality 400 reside on a single cloud based server 300 although it is also possible for each of APE 100 and application functionality 400 to reside on separate servers. It is also possible for components of APE 100 and/or application functionality 400 to themselves be distributed among multiple servers.

In any event, application functionality 400 may be accessed through the Internet or any other private or public network by one or more clients 610. Each of clients 610a, 610b . . . 610n may be personal computers, laptops, handheld computing devices such as smartphones or tablets or any other device capable of providing the required connectivity and display. Clients 610 interact with application functionality 400 such that data may be communicated between them and such that application functionality 400 may process program requests made by Clients 610. By way of example, application functionality 400 may be a computer implemented application which resides on server 300 and which provides a user, acting through a client 610, to analyze and implement stock trades as more fully described below.

Application Permissioning Engine (APE) 100 interacts with application functionality 400 to provide permissioning control as more fully set forth herein. In order for this to occur, application functionality 400 is designed to allow control of specific application features, such as how the user interface is presented on client 610, by APE 100 as well as which functionality is and is not available to a specific user of application functionality 400. In managing permissioning aspects of application functionality 400, APE 100, in a preferred embodiment, may request and receive information from account management system 500. In some embodiments, account management system 500 may reside on server 300 and in other embodiments, it may reside remotely from APE 100 and/or application functionality 400. In either case, account management system 500 receives and responds to requests from APE 100 regarding user and user group characteristics as well as other data which APE 100 may use to make permissioning decisions which are fed to application functionality 400.

As will be more fully described below, account management system 500 may be a sub-component of one or more applications which manage user account information and/or provide specific features and/or functionality to users. For example, account management system 500 may comprise a user management application which manages and tracks user information and relevant data concerning those users in connection with an trading education offering, In this way, account management system 500 may function to register users subscribing to the education offering including demographic data regarding those users and other data such as the level of services that such users have paid for as well as educational attainment and/or course tracks underway and/or completed. This collective set of information which is present in account management system 500 is made available to APE 100 to permit APE 100 to make permissioning decisions to be implemented by application functionality 400 as more fully described below.

Also shown in FIG. 1 is admin client 600. Admin client 600 may be a personal computer, laptop, handheld computing device such as a smartphone or tablet or any other device capable of providing the required connectivity and display. Admin client 600 may be used by an administrator to interact with APE 100 so as to manage permissioning configurations as more fully set forth herein. By way of example only, a system administrator may work at admin client 600 to interact with APE 100 so as to set specific trading instruments which may be traded by a user and which specific trading instruments may not be traded by that same user. This permissioning may be implemented by causing application functionality 400 to either not show unavailable instruments to the user as displayed on the user interface presented at client 610 or by “graying out” unavailable instruments. Other possibilities also exist with respect to how unavailable features and functionalities (based on permissioning) are handled as more fully described below.

In any event, an administrator, interacting through admin client 600 may determine the specific functionality to be made or not available to a user or user group based on data available within account management system 500 with respect to such users and user groups as such data is supplied by account management system 500 to APE 100. By way of example only, an administrator may instruct APE 100 via input through admin client 600 that users that have not completed any courses in options trading will not be permissioned to make options trades via application functionality 400.

Returning now to the specific components of APE 100, APE 100 may include various components for carrying out permissioning analysis and direction. In one embodiment, these components may include administration control 110 (responsible for interaction with an administrator via admin client 600), account data request control 120 (responsible for managing requests for account data from account management system 500), permissioning analysis 130 (responsible for performing permissioning analysis based on data received from account management system and other data available as well as configuration information provided by an administrator) and permissioning control 140 (responsible for interacting with application functionality 400 to receive and respond to requests from application functionality 400 regarding permissioning determinations). Each of these components and their associated functionality are more fully described below.

Server 300 (and other servers not shown but upon which various components of the present invention may reside) may include electronic storage, one or more processors, and/or other components. The servers may also include communication lines, or ports to enable the exchange of information with a network and/or other computing platforms. The servers may include a plurality of hardware, software, and/or firmware components operating together to provide the functionality attributed herein to APE 100, application functionality 400 and/or account management system 500.

Electronic storage associated with the servers may comprise non-transitory storage media that electronically stores information. The electronic storage media of electronic storage may include one or both of system storage that is provided integrally (i.e., substantially non-removable) with servers and/or removable storage that is removably connectable to the servers via, for example, a port or a drive.

Electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage may include one or more virtual storage resources (e.g., cloud storage, a virtual private network, and/or other virtual storage resources). Electronic storage may store software algorithms, information determined by processors, information received from servers, information received from user terminals and/or other information that enables the servers to function as described herein.

While an exemplary architecture is described above, it will readily be understood by one of skill in the art, that an unlimited number of architectures and computing environments are possible while still remaining within the scope and spirit of the present invention. Now that a high level description of the components and architecture associated with the system and methodology of the present invention has been provided, the specific aspects of the novel permissioning methodologies implemented by APE 100 and application functionality 400 are discussed.

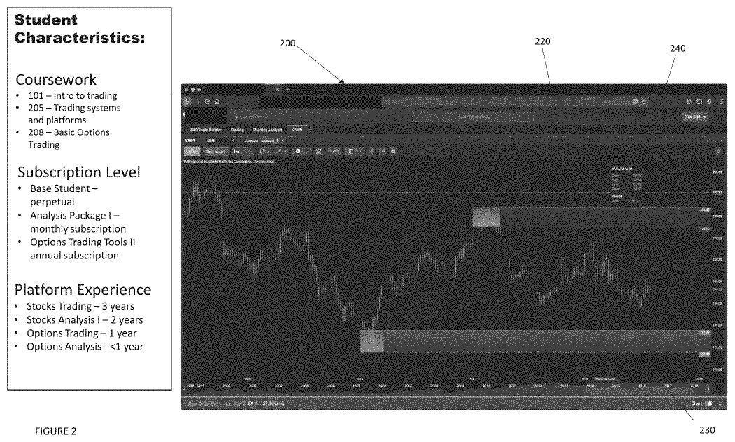

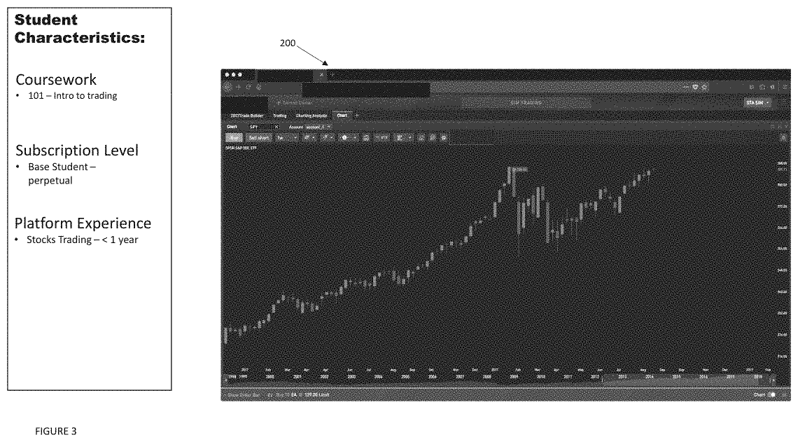

With reference now to FIGS. 2 and 3, two exemplary graphical user interfaces demonstrating the functionality of APE 100, in one embodiment, is provided. In this example, two different users are accessing application functionality 400 via clients 600. The characteristics of each of these two users is shown in FIGS. 2 and 3, respectively. Data reflecting these user characteristics are stored in account management system 500 and made available to APE 100 as controlled by account data request control 120.

The user associated with FIG. 2 (“User 2”) has a substantial amount of trading experience including options trading courses and experience as well as a subscription level that includes Analysis Package I for which User 2 pays a monthly subscription fee. By contrast, the user associated with FIG. 3 (“User 3”) has less experience, less coursework and has paid only a single perpetual license to use the base student functionality. As such, and by way of example only and not by limitation, the user interface presented to User 2 versus User 3 differs in at least one substantial way. As can be seen when comparing FIG. 2 versus FIG. 3, the user interface 200 presented to the more advanced User 2 includes zone drawing bars 220 and 230 as well as informational content 240 associated with these zone drawing bars 220 and 230. By contrast, User 3 is presented with a user interface 200 which does not include either of the zone drawing bars 220 or 230 or the related informational content 240.

In order to provide this exemplary variation in user interfaces 200, APE 100, as discussed above in general terms, requests and receives data from account management system which is associated with each user accessing application functionality 400. The request for this data is managed by account data request control 120. Once the user data is received by APE 100, permissioning analysis 130 operates to apply rules set up by an administrator using an applicable administration interface via admin client 600. In other embodiments, rules which dictate which functionality and which graphical elements are available based on user account information may be hardcoded into APE 100 or alternatively, application functionality 400 may provide some or all of these rules to APE 100.

Once APE 100 receives the requested user account information and permissioning analysis 130 has determined the specific functionality and graphical elements to enable/disable and/or to present or not present, permissioning control 140 operates to instruct application functionality 400 as to such enabling/disabling of functionalities as well as how the presentation on user interface should appear.

It will be understood by one of ordinary skill in the art that APE 100 is extremely flexible and robust in terms of the following:

1) Source and type of user data accessed from account management system 500 and used to perform permissioning—for example, account management system 500 itself may request and retrieve information associated with users and/or groups of users which may be used in applying permissioning rules. Also, an almost unlimited universe of data and data types may be stored and used in accordance with the present invention. For example, demographic data about users or user groups (age, sex, geographic location, marital status, etc.) may be stored and used. Alternatively and/or in addition, other information concerning users and user groups may also be stored and used according to the present invention. Examples include, but are not limited to, education level, course of study, income level, applicable skills, user specified preferences and interests, etc.

2) Types of rules to be applied—many different kinds of rules may be implemented by permissioning analysis 130 of the present invention. These rules may selectively enable or disable functionality based on level of subscription/payment made, based on educational achievement, based on course of study, based on client 610 capabilities or configurations, based on experience levels and many others.

3) Ways that permissioning is actually implemented—based upon application of the aforementioned rules, permissioning control 140 may instruct application functionality 400 to effect the outcome of these rules in many different ways. For example, application of rules may cause certain features to be absent from user interface 200 or, alternatively, these same features may be present but “grayed out”. Similarly, application of these rules may cause the application functionality 400 itself to operate differently based upon the outcome of rule application. By way of example, application functionality 400 may comprise a stock trading analysis application wherein when a novice user is using application functionality 400, the application may operate in a more restricted mode (e.g. only a subset of trading indicators are presented or available for use) compared to a more experienced user where more robust functionality may be available.

Returning now to the example reflected by FIGS. 2 and 3, it should be understood that the difference in presentation as shown via user interface between the two figures may be based on one or any combination of differences between the student characteristics associated with each of the respective users. For example, the lack of zone trading bars 220 and 230 for User 3 may be based on the fact that User 3 did not pay for the Analysis Package I subscription package. However, that is not the only possibility. For example, the absence of the additional functionality in FIG. 3 might also be based on User 3's not yet having stocks analysis I platform experience regardless of whether or not he or she has paid for the Analysis Package I subscription package. As will be readily understood by one of skill in the art, a practically unlimited set of rules and results based on applications of these rules are possible.

The benefits to this approach are numerous. In addition to incentivizing users to pay more for additional functionality a whole new set of improvements is possible through the novel aspects of the present invention. For example, users who are just beginning to use a specific application can be presented with a much simpler interface and only basic features at the start while additional features and complexity can be added as the user adds experience and skills. Similarly, applications can be customized for users based on user characteristics other than skill. experience and/or payment/subscription level. For example, applications can be customized for user groups based on function/role within an enterprise organization. By way of illustration, APE 100 can be configured to provide a customized and unique set of program functionality to employees that have a combination of a minimum level of seniority, job grade and/or experience. Alternatively, APE 100 can be configured to provide a customized and unique set of program functionality to employees who are located in a specific office, have a specific organization role and/or have access to a certain type of hardware. As will be recognized by one of ordinary skill in the art, the possibilities are essentially endless.

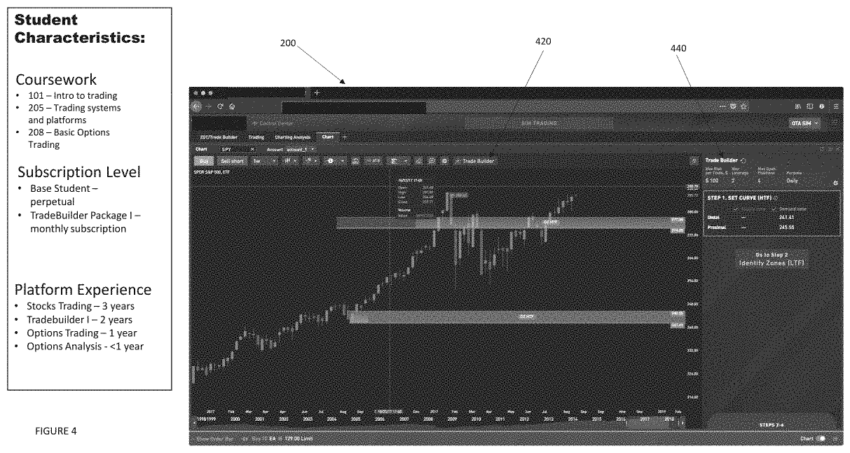

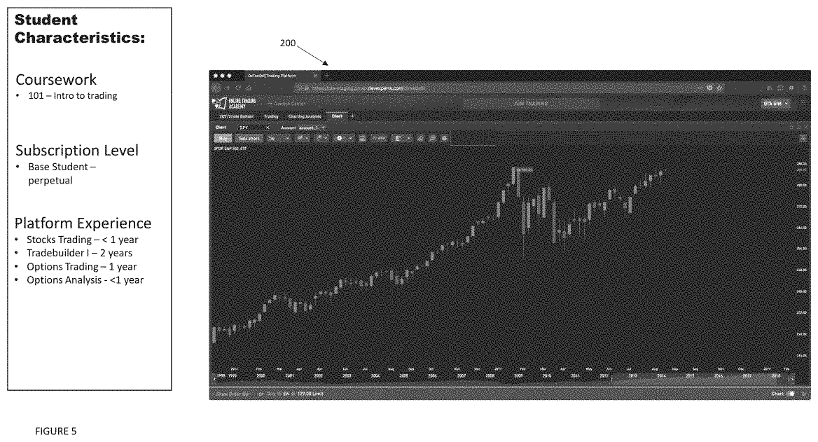

Turning now to FIGS. 4 and 5, another example of the application of the concepts of the present invention is provided so as to demonstrate two different alternative graphical user interface presentations as a result of differences in characteristics of users accessing the application functionality 400. In this case, the user (“User 4”) who is presented with the interface 200 in FIG. 4 has a substantial level of coursework and platform experience and this user also subscribes to a Tradebuilder Package I. By contrast, the user viewing the user interface 200 in FIG. 5 (“User 5”), has less coursework, platform experience and does not subscribe to the Tradebuilder Package I. Because of this difference. User 4 views and has access to various Tradebuilder features (as reflected by the “Tradebuilder button” 420 and the Tradebuilder functionality 440) via user interface 200 while User 5 does not.

To be clear, and by way of example only, APE 100 and application functionality 400 may be alternatively configured such that the Tradebuilder features do NOT require a separate subscription or payment therefore. In this example, User 4 may still be presented with and have access to the Tradebuilder features while User 5 still will not, based, instead, on User 5 not having the required coursework (e.g. not having completed course 205—trading systems and platforms) to trigger access to the Tradebuilder functionality. This may be based on an administrative decision that the knowledge taught in the course is a necessary prerequisite for reliably using the functionality. These and any other rules can be create and imposed by an administrator via access to APE 100.

As will be recognized by one of skill in the art, the unique aspects of the present invention, including the robust ability for an administrator and/or operator of almost any type of application, whether cloud based or otherwise, to dictate selective presentation of user interfaces as well as to selective permission or not permission access to specific functionality based on almost any characteristic or set of characteristics that are associated with a user or group of users accessing the relevant application. In other words, in addition to sales based permissioning (which determines access to features and functionality based upon sales based user characteristics such as subscriptions and/or payment of usage/license fees associated with the user), the present invention also allows for permissioning in other contexts.

One example of this is educational permissioning which allows an application and/or platform to be customized for each student (or groups of students, such as all of those taking a specific course) and to grow with the students as they proceed along an educational path. By way of example, customization can provide beginner, intermediate and advanced modes and these modes can offer selective access to features and functionalities such as technical/educational studies, screen layouts, toolbar icons, badges, avatars and the like. Administrators may also set rules that vary permissioning on a trial basis. For example, a user may be entitled to access certain functionality for a limited period of time after which the user must demonstrate enrollment in a specific class for continued access to that functionality. Many different possibilities also exist.

Selective permissioning provided by the present invention, according to preferred embodiments thereof, may also reflect selective ability to process specific transactions and/or take certain actions. In the context of a trading system, user characteristics can drive control of whether or not a user may process certain trades. For example, if a user has himself set maximum potential drawdowns and/or maximum per trade dollar amounts, the system of the present invention can either prevent or dissuade the user from making a trade that violates those self-imposed restrictions. Relevant messaging can be provided to the user to alert them to potential violations of these restrictions. It is also possible that these restrictions could be imposed by the system administrator based on specific user characteristics. For example, an administrator may set a rule that dissuades a user that has not had an advanced class in option trading from executing an advanced option trade. The user could also be affirmatively prevented from making the trade and/or required to consent to a disclaimer prior to being permitted to execute the trade.

While the present invention has been described primarily in the context of a stock trading application, the teachings of the present invention are by no means limited thereto and can be applied to any application which is used by one or more users that may vary in terms of one or more characteristics. Examples include online educational platforms, gaming applications, productivity applications such as word processors and spreadsheet applications and the like.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

1. An application permissioning system configured to control an application to generate a user interface of said application by selectively enabling application elements corresponding to user characteristic data of a user of said application, said application permissioning system comprising:
an account management system defining a source of a plurality of user characteristic data respectively corresponding to a plurality of users of said application;
one or more processors configured to execute computer program modules, said computer program modules residing on a server and comprising:
an account data receiving module configured to receive first user characteristic data of said plurality of user characteristic data, which is associated with said user of said application;
a rules base comprising at least one rule a plurality of rules for implementing a permissioning determination based on said plurality of user characteristic data, including said first user characteristic data;
a permissioning analysis module for analyzing permissioning according to a first rule, of said plurality of rules, with respect to said first user characteristic data; and
a permissioning control module for receiving permissioning instructions from said permissioning analysis module, and controlling said application to generate a first user interface according to said permissioning analyzed by said permissioning analysis module,
wherein
said permissioning control module controls said application to generate said first user interface of said application corresponding to said user according to said permissioning analysis module applying said first rule, of said plurality of rules, to said first user characteristic data
said account data receiving module is further configured to receive, from said account management system, second user characteristic data, of said plurality of user characteristic data, that is associated with said user and that is different from said first user characteristic data,
said permissioning analysis module is further configured to analyze permissioning according to a second rule, of said plurality of rules, with respect to said second user characteristic data,
said permissioning control module controls said application to generate a second user interface of said application that corresponds to said user, and that is generated according to said permissioning analysis module applying said second rule, of said plurality of rules, to said second user characteristic data, and
at least one of said rules in said rules base comprises a permissioning determination based on user characteristic data of said plurality of user characteristic data, which is not a sales based characteristic.

2.-4. (canceled)

5. The system of claim 1 further comprising an administrative control module accessed by an administrator via an administrative client, said administrative control module receiving instructions from said administrator which are implemented as one or more rules stored in said rules base.

6. The system of claim 1 wherein said application comprises a trading system application.

7. The system of claim 1 wherein said at least one of said rules employs user characteristic data comprising educational attainment to make said permissioning determination.

8. The system of claim 1 wherein said at least one of said rules employs user characteristic data comprising user experience level with said application to make said permissioning determination.

9. The system of claim 1 wherein said at least one of said rules further employs user characteristic data comprising user subscription level to make said permissioning determination.

10. The system of claim 6 wherein said at least one of said rules employs user characteristic data comprising user course path to make said permissioning determination.

11. The system of claim 1 wherein at least one of said rules in said rules base comprises a permissioning determination which selectively enables or disables the ability to process a transaction.

12.-20. (canceled)
